(19) United States
(12) Patent Application Publication
(10) Pub. No.: US 2009/0315775 A1
(43) Pub. Date: Dec. 24, 2009

(54) MOBILE COMPUTING SERVICES BASED ON DEVICES WITH DYNAMIC DIRECTION INFORMATION

(75) Inventors: Moe Khosravy, Bellevue, WA (US); Lev Novik, Bellevue, WA (US); Irena Hudis, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/363,655

(22) Filed: Jan. 30, 2009

Related U.S. Application Data
(60) Provisional application No. 61/074,590, filed on Jun. 20, 2008.

(51) Int. Cl. G01S 3/02

(52) U.S. Cl. 342/452; 342/450

(57) ABSTRACT

Direction based pointing services are enabled for a portable electronic device including a positional component for receiving positional information as a function of a location of the portable electronic device, a directional component that outputs direction information as a function of an orientation of the portable electronic device and a location based engine that processes the positional information and the direction information to determine points of interest relative to the portable electronic device as a function of at least the positional information and the direction information. A set of scenarios with respect to movable endpoints of interest in the system emerge.

### CROSS-REFERENCE TO RELATED APPLICATIONS

This application claims priority to U.S. Provisional Application Ser. No. 61/074,590, filed on Jun. 20, 2008, entitled “MOBILE COMPUTING SERVICES BASED ON DEVICES WITH DYNAMIC DIRECTION INFORMATION”, the entirety of which is incorporated herein by reference.

### TECHNICAL FIELD

The subject disclosure relates to devices, services, applications, architectures, user interfaces and scenarios for mobile computing devices based on dynamic direction information associated with a portable computing device.

### BACKGROUND

By way of background concerning some conventional systems, mobile devices, such as portable laptops, PDAs, mobile phones, navigation devices, and the like have been equipped with location based services, such as global positioning system (GPS) systems, WiFi, cell tower triangulation, etc. that can determine and record a position of mobile devices. For instance, GPS systems use triangulation of signals received from various satellites placed in orbit around Earth to determine device position. A variety of map-based services have emerged from the inclusion of such location based systems that help users of these devices to be found on a map and to facilitate point to point navigation in real-time and search for locations near a point on a map.

However, such navigation and search scenarios are currently limited to displaying relatively static information about endpoints and navigation routes. While some of these devices with location based navigation or search capabilities allow update of the bulk data representing endpoint information via a network, e.g., when connected to a networked portable computer (PC) or laptop, such data again becomes fixed in time. Accordingly, it would be desirable to provide a set of pointing-based or directional-based services that enable a richer experience for users than conventional experiences predicated on location and conventional processing of static bulk data representing potential endpoints of interest.

The above-described deficiencies of today's location based systems, devices and services are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various embodiments, direction based pointing services are enabled for a portable electronic device including a positional component for receiving positional information as a function of a location of the portable electronic device, a directional component that outputs direction information as a function of an orientation of the portable electronic device and a location based engine that processes the positional information and the direction information to determine points of interest relative to the portable electronic device as a function of at least the positional information and the direction information. A set of scenarios with respect to movable endpoints of interest in the system emerge and these scenarios and other embodiments are described in more detail below.

### BRIEF DESCRIPTION OF THE DRAWINGS

Various non-limiting embodiments are further described with reference to the accompanying drawings in which:

FIG. 1 is an exemplary non-limiting flow diagram of an intersection process for performing direction based services with respect to potential moveable endpoints;

FIG. 2 is a block diagram illustrating exemplary formation of motion vectors for use in connection with directional based services and scenarios;

FIG. 3 represents a generic UI for displaying a set of points of interest to a user based on pointing based services;

FIG. 4 is a flow diagram illustrating a non-limiting point and discover scenario;

FIG. 5 represents some exemplary, non-limiting fields or user interface windows for displaying static and dynamic information about a given point of interest;

FIG. 6 is a flow diagram illustrating a non-limiting point and search scenario;

FIG. 7 illustrates a generalized non-limiting intersection algorithm that can be applied to point and discover/search scenarios;

FIG. 8 is a flow diagram illustrating a non-limiting point scenario that dynamically defines the scope of search/filtering for an exemplary pointing process;

FIG. 9 is a block diagram illustrating discovery of individuals in a building in accordance with a non-limiting embodiment of the pointing based services;

FIG. 10 is a flow diagram illustrating a non-limiting dynamically targeted content scenario from other persons of interest;

FIG. 11 is a block diagram illustrating a map-based friends and family tracking scenario;

FIG. 12 is a flow diagram illustrating a non-limiting network switching scenario when connectivity to one or more components is lost;

FIG. 13 is a flow diagram illustrating a non-limiting pointing device based interaction or scenario that can be hosted by an airplane

FIG. 14 is a flow diagram illustrating a business intelligence and reporting scenario for pointing based services;

FIG. 15 is a flow diagram illustrating a ratings and review scenario for pointing based services;

FIG. 16 is a flow diagram of a scenario where a user delays interaction with a point of interest;

FIG. 17 is a flow diagram illustrating a movie theatre scenario for pointing based services;

FIG. 18 illustrates a block diagram of a non-limiting device architecture for pointing based services;

FIG. 19 is a block diagram representing an exemplary non-limiting networked environment in which embodiment(s) may be implemented; and

FIG. 20 is a block diagram representing an exemplary non-limiting computing system or operating environment in which aspects of embodiment(s) may be implemented.

### DETAILED DESCRIPTION

### Overview

As discussed in the background, among other things, current location services systems and services, e.g., GPS, cell triangulation, P2P location service, such as Bluetooth, WiFi, etc., tend to be based on the location of the device only, and tend to provide static experiences that are not tailored to a user because the data about endpoints of interest is relatively static. At least partly in consideration of these deficiencies of conventional location based services, various scenarios based on pointing capabilities for a portable device are provided that enable users to point a device directionally and receive static and/or dynamic information in response from a networked service, such as provided by one or more servers, or as part of a cloud services experience, with respect to one or more movable endpoints in the system.

In one non-limiting aspect, users can interact with the movable endpoints in a host of context sensitive ways to provide or update information associated with endpoints of interest, or to receive beneficial information or other value from entities associated with the movable endpoints of interest. For instance, a set of scenarios are considered herein based on mobile or movable endpoints, e.g., other point devices, in such a system from the perspective a mobile pointing device. Mobile or movable endpoints refers to endpoints that tend to move across geographical regions as the holder/user of the endpoint moves across geographical regions. An otherwise non-movable endpoint can become movable when placed on or within another moving object. A variety of user interfaces can be provided to correspond to such scenarios as well.

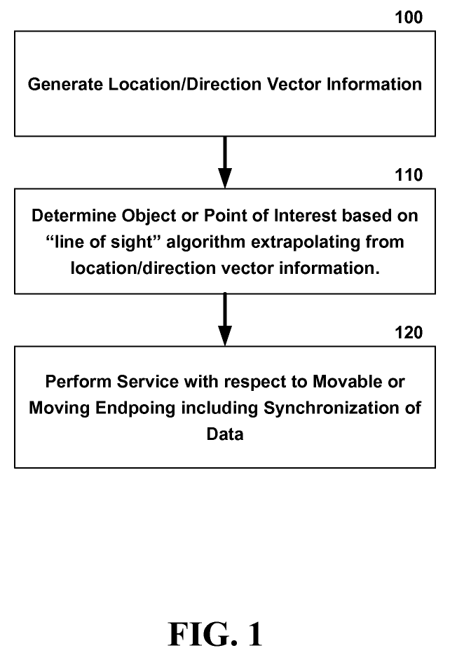

A representative interaction with a set of movable endpoints, such as people wielding pointing device, by a user's pointing device as provided in one or more embodiments herein is illustrated via the flow chart of FIG. 1. At 100, location/direction vector information is determined based on measurements taken by the user's device. Up to date information about movable endpoints of interest can be maintained in the user's device via predictive algorithms that determine where the user will likely be in the future, and where other nearby movable objects will likely be (some will move into the user's path, some will move out of it). This information can also be reported to the network service as part of aggregate business intelligence, upon which further scenarios can be based. For instance, in one business intelligence scenario, the service can link up groups of people that have highly similar interests or behaviors, or intersecting paths. Or, alternatively, groups of people performing inefficient steps in their daily routines can be notified that “a closer coffee shop exists just around the other corner” rather than going 4 blocks out of the way each day.

In various embodiments, algorithms are applied to direction information to define a scope of objects of interest for a device, such as a set of objects displayed within a bounding box or bounding curve shown the display of the device. For instance, ray tracing can be used to define a scope of objects within a certain angle or distance from a device. While in some embodiments, a compass can conveniently provide direction information, a compass is optional. In this regard, any collision detection method can be used to define a set of objects of interest for the device, e.g., for display and interaction from a user. For instance, a bounding curve such as a bounding box, or sphere, of a user intersecting can be used as a basis to display points of interest, such as people, places, and things near the user. As another alternative, location information can be used to infer direction information about the device.

Next, based on the vector information, or more informally, the act of pointing by the user, at 110, a moving or movable object or person of interest, or set of them, is determined based on any of a variety of “line of sight,” boundary overlap, conical intersection, etc. Any algorithms that determine what falls within or outside of the vector scope can be used. It is noted that occlusion culling techniques can optionally be used to facilitate any overlay techniques. Whether the point of interest at issue falls within the vector path can factor in the error in precision of any of the measurements, e.g., different GPS subsystems have different error in precision/resolution.

In this regard, as a result of such an intersection test, one or more movable items or movable points of interest may be found along the vector path or arc, within a certain distance depending on context. The list can be further narrowed based on the user profile, the context of the service, etc., e.g., only moving objects on a road of interest are identified when observing traffic patterns. At 120, a variety of services can be performed with respect to one or more points of interest selected by the user via a user interface. Where only one point of interest is concerned, one or more services can be automatically performed with respect to the point of interest, again depending on context. If a person has declined participation in a service, however, a mechanism is provided that allows that person to turn on and turn off sharing of user information.

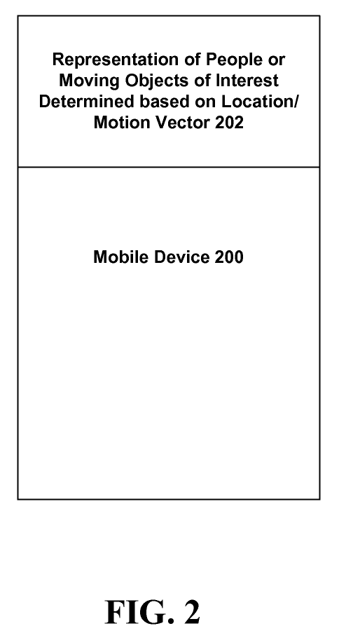

As shown in FIG. 2, once a set of objects is determined from the pointing information according to a variety of contexts of a variety of services, a mobile device 200 can display the objects via representation 202 according to a variety of user experiences tailored to the service at issue. For instance, a virtual camera experience can be provided, where POI graphics or information can be positioned relative to one another to simulate an imaging experience, showing names of people over their heads, e.g., for networking events or parties. A variety of other user interface experiences can be provided based on the pointing direction, where the points of interest determined by the act of pointing are represented on screen via a user interface representation 202 suited for the scenario or service.

Based on a device having pointing capabilities that can define a direction motion vector for the device, as described herein, a broad range of scenarios can be enabled where web services effectively resolve vector coordinates sent from mobile endpoints into <x,y,z> or other coordinates using location data, such as GPS data, as well as configurable, synchronized POI information similar to that found in a GPS system in an automobile. In this regard, any of the embodiments can similarly be applied in any motor vehicle device, or other transportation vehicle, such as a bus. As described in more detail below, one non-limiting use is also facilitation of mobile endpoint discovery for synchronization of data of interest to or from the user from or to another user.

In a non-limiting implementation of a pointing device, an accelerometer can be used in coordination with an on board digital compass, and an application running on the device updates what each endpoint is “looking at” or pointed towards, performing hit detection on potential points of interest to either produce real-time information for the device or to allow the user to select a range for potential objects (e.g., people inside this Starbucks). One or more accelerometers can also be used to perform the function of determining direction information for each endpoint as well. Or, using the GPS system, a location on a map can be designated on a map, and a set of information provided to the user about various endpoints, such as “Your friend Bill happens to be driving three cars ahead of you” or “Your teenager has just entered a bar.”

Accordingly, a general device for accomplishing these and other scenarios described herein includes assets to resolve a line of sight vector sent from a mobile endpoint and a system to aggregate that data as a platform, enabling a host of new scenarios predicated on the pointing information known for the device, and other devices in the system. In this regard, the pointing information and corresponding algorithms depend upon the precision of the assets available in a device for producing the pointing information. The pointing information, however produced according to an underlying set of measurement components, and interpreted by an engine, can be one or more vectors. A vector or set of vectors can have a “width” or “arc” associated with the vector for any margin of error associated with the pointing of the device. A panning angle can be defined by a user with at least two pointing actions to encompass a set of points of interest, e.g., those that span a certain angle defined by a panning gesture by the user. add a field of view component? (Vectors can also have an associated FOV to limit what is in the scope or view of the user

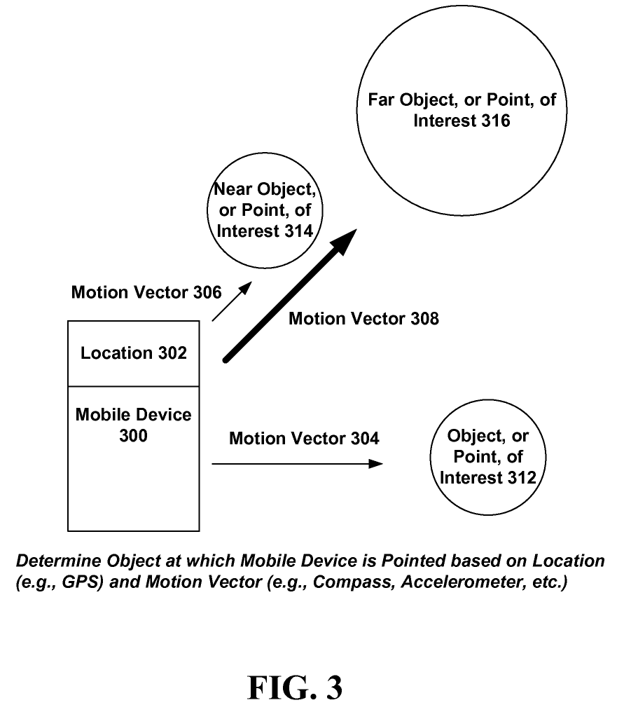

An exemplary, non-limiting algorithm for interpreting position/motion/direction information is shown in FIG. 3. A device 300 employing direction based location based services 302 in a variety of embodiments herein includes a way to discern between near objects, such as POI 314 and far objects, such as POI 316. Depending on the context of usage, the time, the user's past, the device state, the speed of the device, the nature of the POIs, etc., the service can determine a general distance associated with a motion vector. Thus, in the example, a motion vector 306 will implicate POI 314, but not POI 316, and the opposite would be true for motion vector 308.

In addition, a device 300 includes an algorithm for discerning items substantially along a direction at which the device is pointing, and those not substantially along a direction at which the device is pointing. In this respect, while motion vector 304 might implicate POI 312, without a specific panning gesture that encompassed more directions/vectors, POIs 314 and 316 would likely not be within the scope of points of interest defined by motion vector 304. The distance or reach of a vector can also be tuned by a user, e.g., via a slider control or other control, to quickly expand or contract the scope of endpoints encompassed by a given “pointing” interaction with the device.

In one non-limiting embodiment, the determination of at whom the user is pointing is performed by calculating an absolute “Look” vector, within a suitable margin of error, by a reading from an accelerometer's tilt and a reading from the magnetic compass. Then, an intersection of endpoints determines an initial scope, which can be further refined depending on the particular service employed, i.e., any additional filter. For instance, for an apartment search service, endpoints falling within the look vector that are not apartments ready for lease, can be pre-filtered.

In addition to the look vector determination, the engine can also compensate for, or begin the look vector, where the user is by establish positioning (˜15 feet) through an A-GPS stack (or other location based or GPS subsystem including those with assistance strategies) and also compensate for any significant movement/acceleration of the device, where such information is available.

One non-limiting way for achieving this is to define an arc or an area within an arc and a corresponding distance that encompasses certain POI, but does not encompass other POIs. Such an algorithm determines edge case POIs where they partially fall within the area defined by the arc and distance. For another non-limiting example, with location information and direction information, a user can input a first direction via a click, and then a second direction after moving the device via a second click, which in effect defines an arc. The area of interest implicitly includes a search of points of object within a distance, which can be zoomed in and out, or selected by the service based on a known granularity of interest, selected by the user, etc. This can be accomplished with a variety of forms of input to define the two directions. For instance, the first direction can be defined upon a click-and-hold button event, or other engage-and-hold user interface element, and the second direction can be defined upon release of the button. Similarly, two consecutive clicks corresponding to the two different directions and can also be implemented. In effect, this technique defines a panning motion across a set of endpoints. This could be further enhanced by usage of a differential GPS solution to obtain more accuracy.

A gesture subsystem can also be included in a device. In this regard, one can appreciate that a variety of algorithms could be adopted for a gesture subsystem. For instance, a simple click-event when in the “pointing mode” for the device can result in determining a set of points of interest for the user. Other gestures can indicate a zoom in or zoom out operation, and so on.

Other gestures that can be of interest in for a gesturing subsystem include recognizing a user's gesture for zoom in or zoom out. Zoom in/zoom out can be done in terms of distance. Also, instead of focusing on real distance, zooming in or out could also represent a change in terms of granularity, or size, or hierarchy of objects. For example, a first pointing gesture with the device may result in a shopping mall appearing, but with another gesture, a user could carry out a recognizable gesture to gain or lose a level of hierarchical granularity with the points of interest on display. For instance, after such gesture, the points of interest could be zoomed in to the level of the stores at the shopping mall and what they are currently offering.

In addition, a variety of even richer behaviors and gestures can be recognized when acceleration of the device in various axes can be discerned. Panning, arm extension/retraction, swirling of the device, backhand tennis swings, breaststroke arm action, golf swing motions could all signify something unique in terms of the behavior of the pointing device, and this is to name just a few motions that could be implemented in practice. Thus, any of the embodiments herein can define a set of gestures that serve to help the user interact with a set of services built on the pointing platform, to help users easily gain information about points of information in their environment.

Furthermore, with relatively accurate upward and downward tilt of the device, in addition to directional information such as calibrated and compensated heading/directionality information, other services can be enabled. Typically, if a device is ground level, the user is outside, and the device is “pointed” up towards the top of buildings, the granularity of information about points of interest sought by the user (building level) is different than if the user was pointing at the first floor shops of the building (shops level), even where the same compass direction is implicated. Similarly, where a user is at the top of a landmark such as the Empire State building, a downward tilt at the street level (street level granularity) would implicate information about different points of interest that if the user of the device pointed with relatively no tilt at the Statue of Liberty (landmark/building level of granularity).

Also, when a device is moving in a car, it may appear that direction is changing as the user maintains a pointing action on a single location, but the user is still pointing at the same movable object—the angle change is merely due to displacement of the device. Thus, time varying location can be factored into the mathematics and engine of resolving at what the user is pointing with the device to compensate for the user experience based upon which all items are relative.

Accordingly, armed with the device's position, one or more web or cloud services can analyze the vector information to determine at what or whom the user is looking/pointing as well as services that tell the user about the location of other users, e.g., perhaps on other services like MySpace, Match, Facebook, etc. The service can then provide additional information such as ads, specials, updates, menus, happy hour choices, etc., depending on the endpoint selected, the context of the service, the location (urban or rural), the time (night or day), etc. As a result, instead of a blank contextless Internet search, a form of real-time visual search for users in real 3-D environments is provided.

The act of pointing with a device, such as the user's mobile phone, thus becomes a powerful vehicle for users to discover and interact with points of interest around the individual in a way that is tailored for the individual. Synchronization of data can also be performed to facilitate roaming and sharing of POI data and contacts among different users of the same service.

In a variety of embodiments described herein, 2-dimensional (2D), 3-dimensional (3D) or N-dimensional directional-based search, discovery, and interactivity services are enabled for endpoints in the system of potential interest to the user. one scenario includes pointing to a building, using the device's GPS, accelerometer, and digital compass to discover the vector formed by the device and the POI location to which the user is pointing. If no information exists, the user can enter information about the object or location, which can be synchronized to the applicable service.

Another exemplary, non-limiting scenario includes point and click synchronization where, for instance, a web service and application allow users to point and sync contacts, files, media, etc. by simply locating another endpoint using line of sight. Synchronization can occur through the cloud or directly via WIFI/BlueTooth, etc.

In one non-limiting embodiment, the direction based pointing services are implemented in connection with a pair of glasses, headband, etc. having a corresponding display means that acts in concert with the user's looking to highlight or overlay features of interest around the user.

While each of the various embodiments below are presented independently, e.g., as part of the sequence of respective Figures, one can appreciate that an integrated handset, as described, can incorporate or combine two or more of any of the embodiments. Given that each of the various embodiments improve the overall services ecosystem in which users wish to operate, together a synergy results from combining different benefits when a critical user adoption mass is reached. Specifically, when a direction based pointing services platform provides the cross benefits of different advantages, features or aspects of the various embodiments described herein, users are more likely to use such a beneficial platform. As a generally recognized relationship, the more likely users will be to use, the more the platform gains critical mass according to the so-called network effect of adoption. Any one feature or service standing alone may or may not gain such critical mass, and accordingly, the combination of different embodiments described below shall be considered herein to represent a host of further alternate embodiments.

Details of various other exemplary, non-limiting embodiments and scenarios predicated on portable pointing devices are provided below.

### Pointing Device Scenarios for Moveable Points of Interest

As mentioned, a variety of scenarios are described herein for pointing based location services for mobile devices with respect to relatively mobile endpoints. With A-GPS or other GPS subsystems and accelerometers together with a magnetic compass, mobile devices, such as phones, can easily answer a variety of questions simply by pointing with the device. For instance, in retail/merchandising scenarios, a user can quickly point to the store and discover “Where is the manager?” Or “I wonder whether that cute employee is single” Or “I wonder if any of my friends are at this concert” Or “Do I have anything in common with this group of people?”

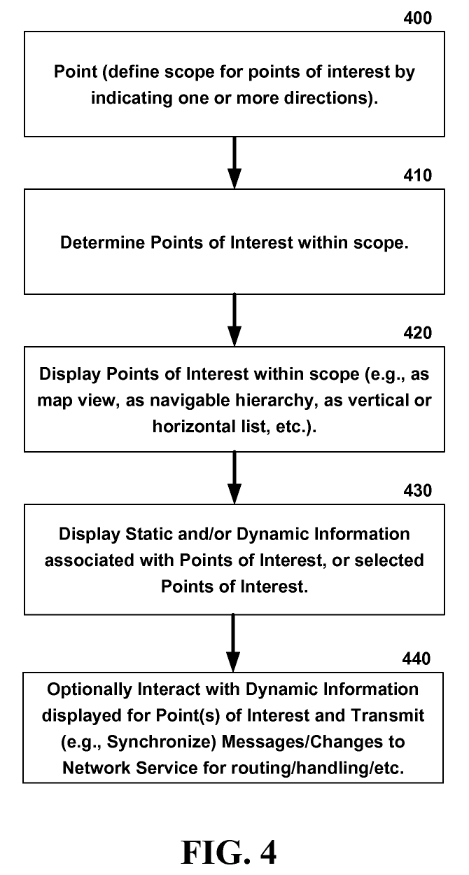

In this regard, a mobile device with pointing capabilities can be operated in an information discovery mode in which the user of the device is walking, turning, driving, etc. and pointing to various movable objects (other users, cars, airplanes, etc.) as part of various scenarios to get information as well as to interact with them. In effect, the user possesses a magic wand to aim at people and other moving points of interest, etc. and get/set get/set information with the click of a button, or other activation of the service. FIG. 4 is a flow diagram of a non-limiting process for achieving a point and discover scenario.

At 400, the device is pointed in one or more directions, and according to one or more gestures, depending on device capabilities, thereby defining the scope for points of interest by indicating one or more directions. At 410, based on motion vectors determined for the pointing, a service determines current points of interest within scope. At 420, points of interest within scope are displayed, e.g., as map view, as navigable hierarchy, as vertical or horizontal list, etc. At 430, static and/or dynamic information associated with the points of interest, or selected points of interest, is displayed. The points of interest data and associated information can be pre-fetched to a local cache for seamless processing of point and discover inquiries. For selecting points of interest, various user interfaces can be considered such as left-right, or up-down arrangements for navigating categories, or a special set of soft-keys can be adaptively provided, etc. At 440, the user can optionally interact with dynamic information displayed for point(s) of interest and such changes/message can be transmitted (e.g., synchronized) to network storage for further routing/handling/etc.

A sample use of the point and discover scenario from the perspective of a user of a pointing device can be: “I just moved nearby to this location, but do not know much about people in my surroundings. I will point my device down this street and discover what people generally are discoverable, and then learn about a distant family relative nearby as part of navigating the result list.” Another example is a scenario of a social network application or a game of tag among children.

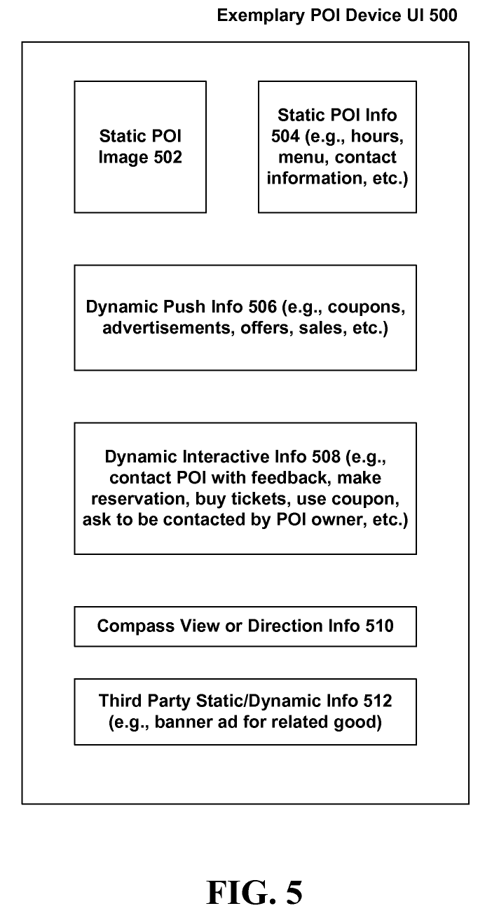

Once a particular point of interest is identified by the user explicitly or implicitly as a point of interest the user wants to know more about, the particular point of interest can be displayed on the device in a more detailed format, such as the format shown in the representative UI of FIG. 5 illustrating a full screen view via exemplary non-limiting UI 500.

UI 500 of FIG. 5 can have one or more of any of the following representative areas. UI 500 can include a static POI image 502 such as a picture of a person. UI 500 can also include other media, and a static POI information portion 504 for information that tends not to change such as birthday, eye color, etc. In addition, UI 500 can include an information section for dynamic information to be pushed to the user for the POI, e.g., “join my club,” “meet me later at the Grill where I'll be,” etc. In addition, dynamic interactive information 508 can be included where the user can fill out a survey about their first impression with the person, provide feedback to the manager of a store, request to be contacted, etc. UI 500 also can include a representation of the direction information output by the compass for reference purposes. Further, UI 500 can include other third party static or dynamic content in area 512. Thus, there are a variety of ways to interact with the content of a discovered point of interest.

When things change from the perspective of either the service or the client, a synchronization process can bring either the client or service, respectively, up to date. In this way, an ecosystem is enabled where a user can point at an object or point of interest, gain information about it that is likely to be relevant to the user, interact with the information concerning the point of interest, and add value to services ecosystem where the user interacts. The system thus advantageously supports both static and dynamic content.

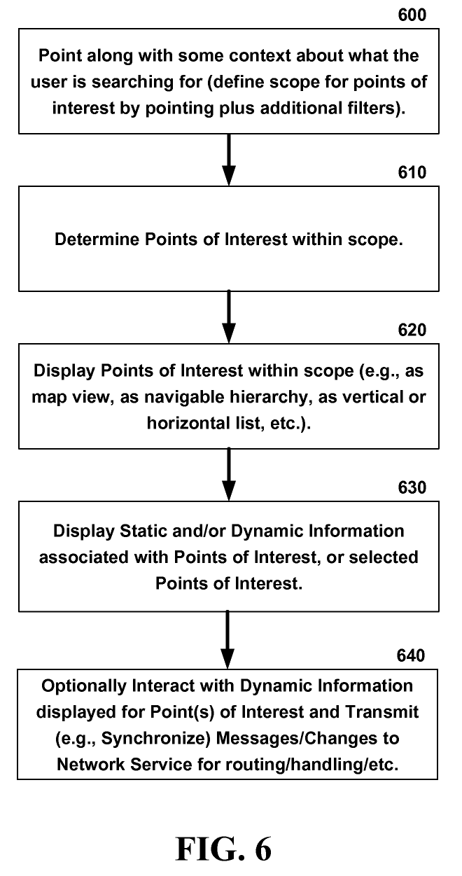

In this respect, a scenario is enabled where a user merely points with the device and discovers persons of interest and information of interest in the process. Taking the scenario a step further, pointing can also be in effect a form of querying of the service for points of interest, thereby providing a point and search experience. Thus, a user can inform a pointer device to find any other people that also enjoy underwater basketweaving since it is a rare hobby and hard to find other enthusiasts. FIG. 6 is a flow diagram of a non-limiting process for achieving a point and search scenario.

At 600, a user points a device along with some context about what the user is searching for, either explicitly (e.g., defining search terms or tracking specific movable property as it ships through Fed Ex) or implicitly (e.g., “Use of a Matchmaking Service” to define scope for movable objects of interest along the pointing direction plus any additional filters represented by the search context. At 610, based on motion vectors determined for the pointing, a service determines current objects of interest (e.g., people) within scope. At 620, objects of interest within scope are displayed, e.g., as map view, as navigable hierarchy, as vertical or horizontal list, etc. At 630, static and/or dynamic information associated with the objects of interest, or selected objects of interest, is displayed. The objects of interest data and associated information can be pre-fetched to a local cache for seamless processing of point and discover inquiries. For selecting objects of interest, various user interfaces can be considered such as left-right, or up-down arrangements for navigating categories, or a special set of soft-keys can be adaptively provided, etc. At 640, the user can optionally interact with dynamic information displayed for object(s) of interest and such changes/message can be transmitted (e.g., synchronized) to network storage for further routing/handling/etc.

The concept of “match making” by pointing to people or by knowing who is in the vicinity, e.g., when certain conditions, search criteria, states, etc. are met, can also be extended to cover static, or non-movable POIs as well, as opposed to just people. For instance, a scenario of filters and favorites can be implemented based on historical match making information tracked by the pointing based services system, such that loyalty and frequent shopper programs can be dynamically offered where it is believed a correlated match is made with a user.

The point and search scenario could apply to game of tag, an outdoor first person shooter game using the pointer devices as the aiming/shooting weapon. The point and search scenario could help a user find dates, friends, hobbyists, etc.

In this regard, scenario based filtering implicates a lot of different ways to filter a potential set of points of interest especially in crowded spaces of points of interest where a user will desire to filter through a lot of noise that is not relevant to the user, which is uncovered during the generalized point and discover scenario.

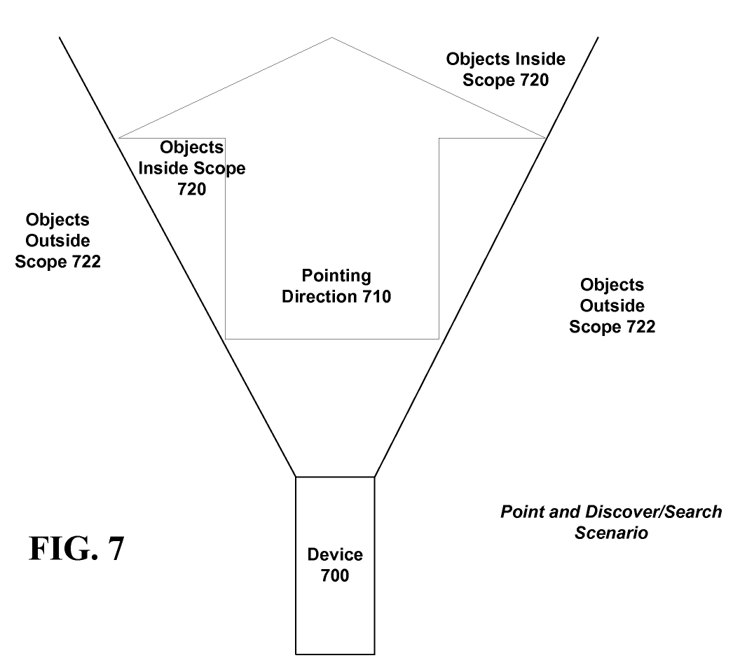

For instance, as illustrated in FIG. 7, for a point and discover or search scenario, a device 700 points according to one or more directions 710 (one direction shown for simplicity) to define a scope of objects. Objects 720 are then inside the scope and objects 722 are outside the scope, and different scenarios can implement such process differently. This can be applied to people as objects, or other moving objects according to any of the following exemplary, non-limiting scenarios.

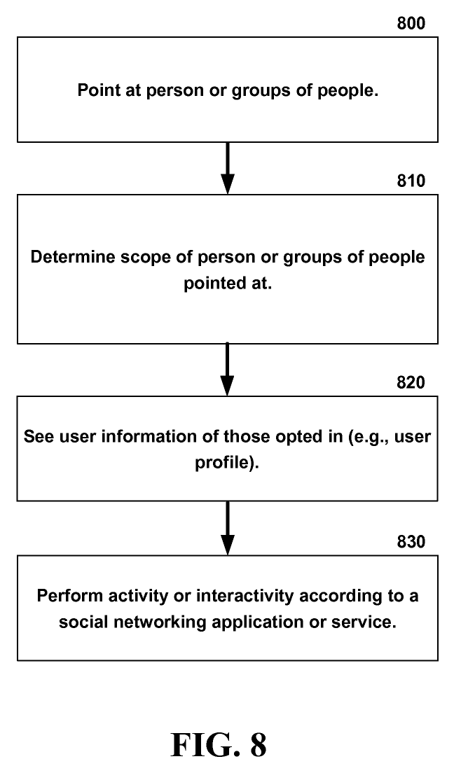

FIG. 8 is a flow diagram representing an exemplary non-limiting process for discovering people. At 800, a user points at a person or groups of people. At 810, the scope of people being pointed at is determined, one or more other people (pets, robots, etc.). Various algorithms can be applied to determine intent behind the pointing act depending on how many people are within scope, how far away they are, context, etc. At 820, information of those objects within scope are displayed (e.g., user profiles). For those users that have opted in, users can share information, including personal information, or profiles from third party social networking applications. At 830, a user can optionally act or interact with other users within scope of the pointing act according to a social networking application or service.

Thus, by the act of pointing, a whole variety of real-time social networking scenarios are enabled in a user's real physical space. Each user includes an identity that can be represented in other device's UI in whole or in part, or not at all. The identity can include personal advertisements (“I'm Stuart Smalley, and I like myself!”), initiate an electronic business card exchange, solicitations for used furniture, a challenge to a game of Tetris, etc. The possibilities for interaction are limitless. Any changes a user makes to his or her identity are synchronized to the network service, thereby becoming available for others to see. For instance, a user can indicate “what I'm doing this weekend” and friends who wish to discover this information can “find me” and discover my exact location via GPS guidance.

Thus, the invention enables a host of scenarios around, find me friends, find my friends, find my family and tell me about that person or group of people. In this respect, users can implicitly or explicitly organize into a block of pointing devices (e.g., the three pointing Musketeers, Siamese twins) which are handled separately, but also together. For instance, a set of kids can be arranged as a group, so that parents can in effect say “point me to my children” and see them on a map within scope. For a request such as this one, it is the request that sets the scope of the map, and thus this is a good example of dynamic setting of scope of intersection to display with the pointing device. Then, direction information can easily point the user where to go to find a missing child.

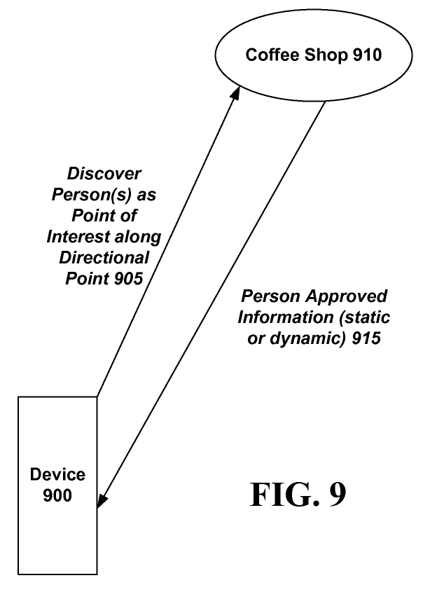

FIG. 9 illustrates a block diagram showing casual discovery by a pointing device 900 of people in a coffee shop 910. Device 900 discovers person(s) as point of interest along directional point 905, and is returned a set of people. In one embodiment, only person approved information (static or dynamic) 915 is returned to the device 900 so that people can opt out wholly, partially, or participate.

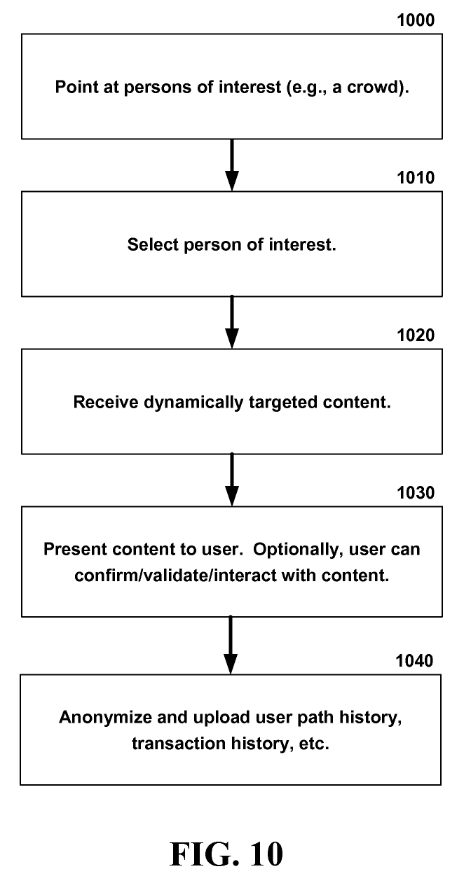

FIG. 10 is a flow diagram showing a corresponding process for discovering information about a person or group of people. At 1000, a user points at persons of interest. At 1010, the user selects one or more persons of interest from a result set returned by the service, or retrieved from a local cache. At 1020, based on the selected person(s), the user can receive dynamically targeted content from the selected people, such as: “I live in downtown Seattle, join my book club,” and “I play on an ice hockey team and we really need a defenseman because one of our players was injured, so let me know if you know of one.” At 1030, the content is presented to the user. Optionally, the user can confirm/validate/interact with content. At 1040, the user can choose to anonymize and upload user path history, transaction history, etc. to the network service to fuel better targeted content in the future based on richer user profile information.

Thus, a find or discover others scenario is enabled where the pointing system knows where everyone is and what they are looking at, which can include other users or movable objects, and designating people as friends and families for various social networking applications. As a result, one can easily find friends at a concert or a crowded mall, build a real-life first person shooter via line of sight principles of pointing and tracking the movement of each participant. Similarly, a game of tag could be played by a set of users based on similar principles. More socially minded, a user can ask “Does she or he standing over there have a Facebook account? Let me point to him or her and find out if she's opted to show his or her profile . . . .”

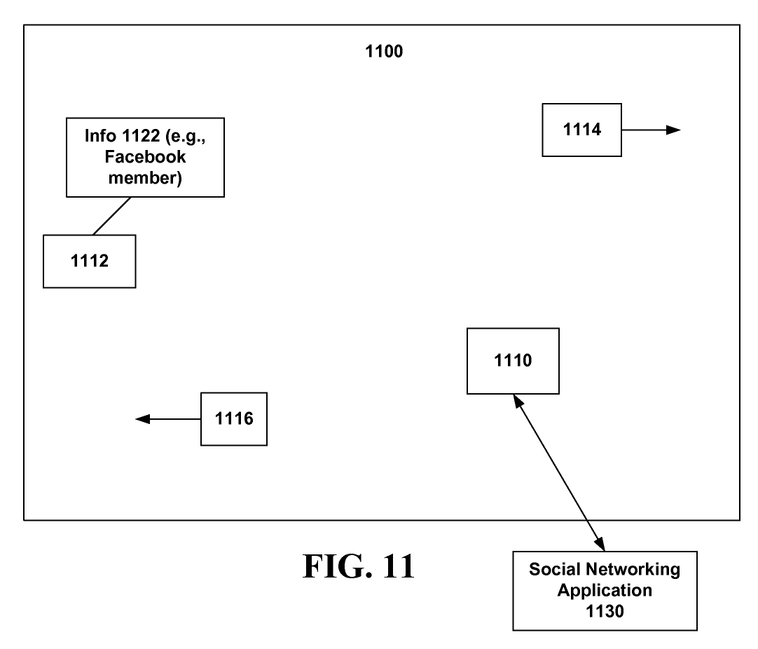

FIG. 11 is a block diagram of a parental monitoring mode, or “Harry Potter” object movement tracking map that shows the user's friends, or allows parents to see the whereabouts of their children, on a map with arrows on how to find them, and arrows or movement illustrating how the subjects are moving. Such embodiment can work for tracking any moving assets. A user can zoom in or out with respect to any one of the assets and discover more or less information about the person.

In FIG. 11, user 1110 in space 1100 (concert, park, mall, movie theatre, etc.) can see his or her friends 1112, 1114 and 1116. For instance, “Where are my friends at this outdoor concert?” Based on the representation of space 1100, the user 1110 can see that friend 1116 is moving left and friend 1114 is moving right, and friend 1112 is staying still. By clicking on friend 1112, user 1110 ascertains user 1112 has a social networking account, such as Facebook, whereby user 1110 can learn more information about friend 1112 from social networking application 1130, such as Facebook. As mentioned, a user can zoom in and out of the spaces hierarchically if the user does not see friends, family within scope. Another scenario is for the user to control the device to say, “show me where Barbara is.” Barbara may be represented by 1116 and walking away from the user, as shown in FIG. 11. Thus, this could be used to find temporarily missing children in the aisles of a supermarket. The user could also set an alert on the device that if children leave a radius from the user, or leave the GPS location 1100 as indicated by some boundary conditions, then the user is immediately alerted.

With respect to viewing one another's information, users can change any dynamic information, or otherwise interact with it and send the changes to the network. For instance, “Some information is missing—I think I'll add it for myself and others to find.” Thus, a variety of social scenarios are enabled by a set of pointing devices and associated users. Users can find friends and family, and literally have their pointing enabled device show an arrow that points to them, or directions of how to get to them the fastest. The pointing device enables a user to discover other endpoints of a social network that opt in to participation. Social scenarios, such as hobby matching or love chemistry correlation and analysis can be performed. A user might be standing next to their dream husband or wife, and not even know it. For rare hobbies, users can discover other users with the same rare interest.

With respect to users' control over their information, the system can provide visibility options, such as the following non-limiting options: (A) Show my profile only to my friends, (B) Show my profile to everyone, (C) Show my profile to people who match “these properties” or (D) Facilitates friend discovery, dating, interest groups, etc.

The pointing based services can also be used by naturalists wishing to analyze the habits of a certain species of animal. Thus, while the above described constructs are in the context of people, substitution of any moving living thing, or any moving object, such as a car, or airplane, represents a whole different set of useful scenarios.

As mentioned, a set of pointing devices and users can engage in games and entertaining activities such as a simulated real life first person shooter, tag, capture the flag, etc. In addition, because the path data of users is available, the users can watch how the game was played afterwards to avoid getting caught in the same trap as last time, capture instant replay scenarios, etc.

In another set of network connectivity scenarios, movement of pointing devices implies the traversal of networks and connectivity, going offline temporarily and going back online when possible. Thus, to improve this situation, when a user is inside a bus, or mass transit, or subway at particular stop, and has lost GPRS or GPS connectivity, if another enabled pointing device is inside the bus, then the user can connect to that user via Bluetooth and leverage the working resources of the neighboring device. Or, alternatively, the bus itself could have a pointing device, or a GPS subsystem, any of which can broadcast to bus users' pointing device for their use. A similar concept applies to tour guides at a museum. Instead of a GPRS network, a pointing device can get information about museum artifacts from Bluetooth information available about it, or from a neighboring device that does have GPR connectivity. In this regard, any third party could be broadcasting GPS information via Bluetooth in areas, such as inside, where GPS or GPRS connectivity is limited. Also, for the same reason, Bluetooth service can be used for discovering other pointing device users indoors for any of the above-described social networking scenarios.

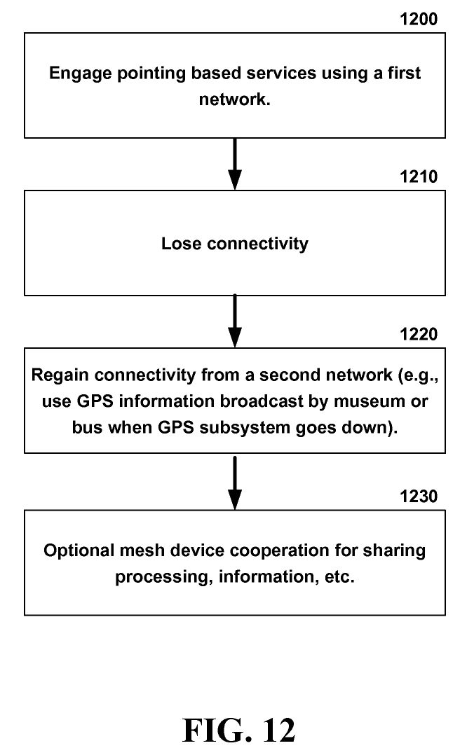

FIG. 12 illustrates a process for switching among channels for any of missing infrastructure to engage in pointing based services. At 1200, the user engages pointing based services using a first network, but then one or more aspects of connectivity are lost at 1210. At 1220, connectivity is regained from a second network, e.g., local Bluetooth network, other user pointing devices, etc. In addition, at 1230, any users who have opted in for mesh device cooperation can share processing resources, information missing from other devices within the cooperative network, for instance, if one device has the missing information in its local cache, etc.

The possibilities for mesh networking based on movable endpoints in a pointing based device system are limitless. For instance, one mesh network scenario would be to determine actual traffic patterns by uploading user path data from millions of users over the country for one year. What would emerge from such a large mesh network of cooperating users is data about roads that statistically represents traffic for various conditions on those roads, e.g., at night, when raining, time of day, etc. Thus, a driving or direction service predicated on such information and the actual paths that drivers take down the roads including all of their turns can be more effective than the mathematical assumptions made by navigation systems today.

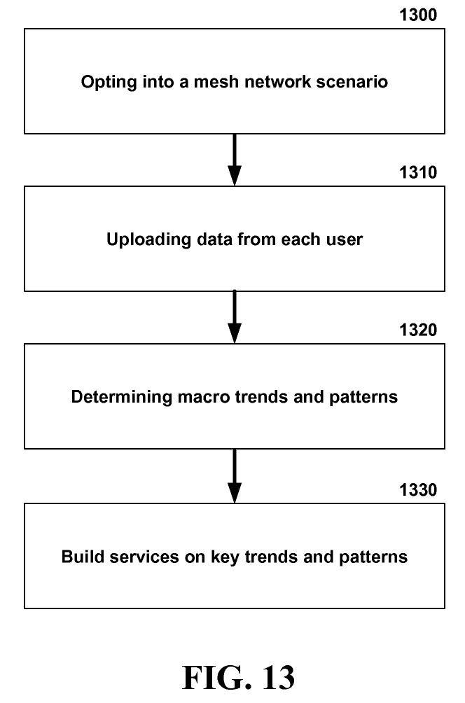

All of the user data, user paths, user transactions, and interactions can thus be uploaded to a network service that tracks business intelligence about people or groups of people. FIG. 13 is a flow diagram illustrating the creation of business intelligence from these types of social scenarios and user interactions. At 1300, users opt into one or more cooperative mesh network scenarios, e.g., “use my car data to build road data.” At 1310, the data from each user is collected and aggregated over time and at 1320, the aggregate data is examined for macro trends and patterns. As a result of the key trends and patterns discovered, at 1330, services can be built on key trends and patterns, such as the improved directions based on actual user path data. The trends and patterns can be organized into additional reports and subscription data in which various marketing or other organizations may be interested.

In addition, customized scenarios can be designed for different types of devices, or for different types of placement of those devices. For instance, a set of services for a biker is different than the set of services that a car driver wants. Thus, that different kinds of moving objects inherently have different requirements, e.g., a biker does not need gas.

In addition, as airplanes are considering adding network connectivity to the suite of onboard services, a pointing device can also be advantageous in the airplane. In this regard, leveraging the instrumentation of the plane itself, or of other location and direction information available on the plane through an alternate network, point of interest information can be customized to different users on board. For instance, grandma can learn that there is a knitting museum in Chicago, and junior can learn that the rock and roll hall of fame is in Cleveland as the respective users fly over different regions of the world.

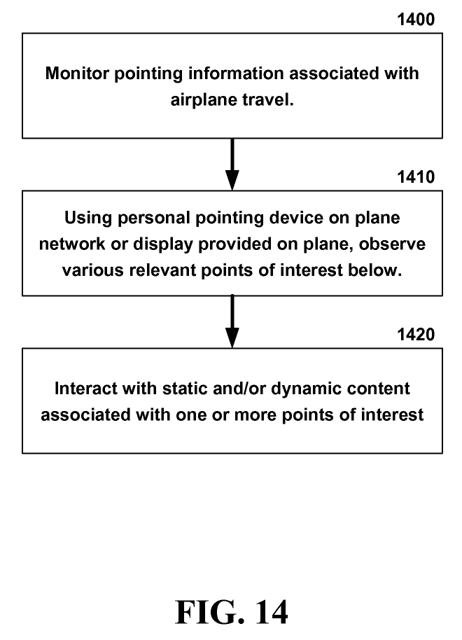

FIG. 14 represents an exemplary process for such a scenario via a flow diagram. At 1400, pointing information associated with airplane travel can be monitored on an ongoing basis. At 1410, a user using a personal pointing device on the plane network, or using the display device provided in the plane seats, observes various relevant points of interest below on screen. These can be customized for the user, or the user can free form navigate the system in a discovery or search mode. At 1420, as with the on land scenarios, a user can interact with any static and/or dynamic content associated with one or more points of interest on the ground. Similar infrastructure can be implemented for any form of transportation.

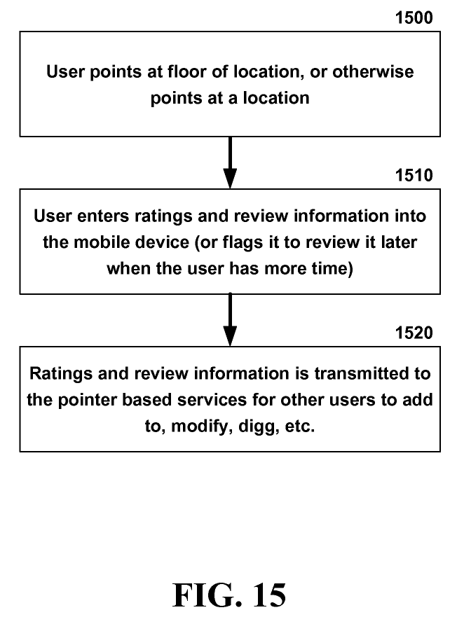

FIG. 15 represents another scenario based on pointing based services that enables users to instantly rate and review a location. User points at floor of location, or otherwise points at a location. User enters ratings and review information into the mobile device (or flags it to review it later when the user has more time). Ratings and review information is transmitted to the pointer based services for other users to add to, modify, digg, etc.

As alluded to in FIG. 11, for the avoidance of doubt, the pointing services platform can leverage participating third party services, such as pre-existing dating sites, review sites, ranking sites, social networking sites, to plug them into the pointing user experience and platform. Thus, the various embodiments herein are all extensible to third party user information, and it is the pointing experience that makes the extension and exposure beneficial to all in a simple and intuitive “I have a goal, and I can get to it by pointing” manner.

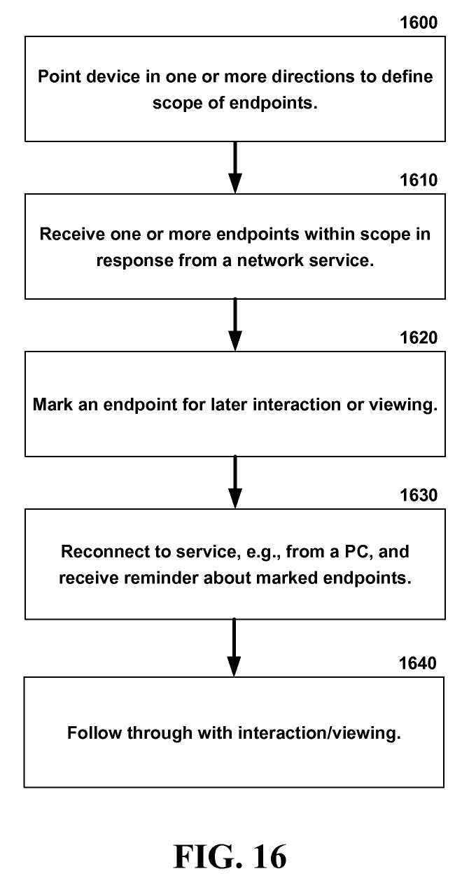

In one aspect, a delayed typing scenario can be realized for any scenario. For instance, typing on a mobile device can be inconvenient. Thus, via the service, a user can point at a point of interest, and mark the point of interest for later action. Thus, when the user reaches a PC, a reminder to interact with the point of interest is present and the user can type with a full keyboard. This is illustrated in the flow chart of FIG. 16.

At 1600, a user points a pointer device in one or more directions to define scope of endpoints. At 1610, the user receives an indication of one or more endpoints within scope in response from a network service. At 1620, the user marks endpoint(s) for later interaction or viewing. At 1630, when the user reconnects to the service, e.g., from a PC, the user can receive reminders about marked endpoints and follow through with interaction/viewing at 1640, as desired. Accordingly, delayed editing of dynamic information flowing through the pointing based database is enabled providing the ability to “Mark this location” or to add information about a point of interest directly on the device (or service) through delayed editing. This can be supported with pictures, audio, automatic annotations, etc. to remind the user of why they wanted to add a particular GPS location as interesting.

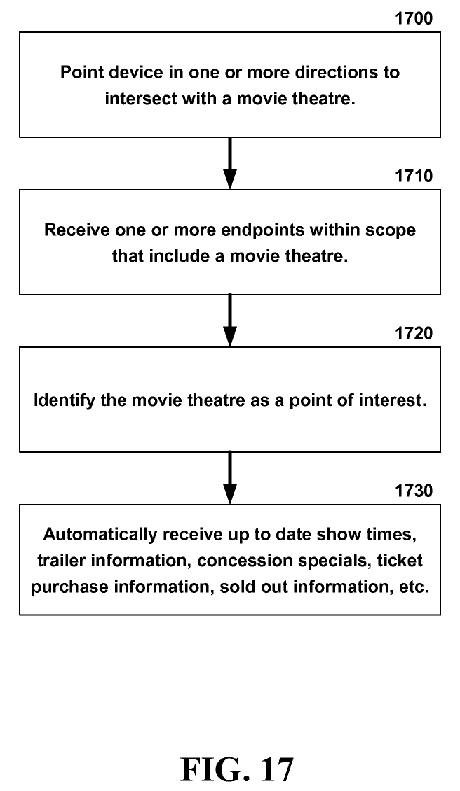

FIG. 17 illustrates a scenario where a movie theatre provides times as well as movie trailers just by pointing to the movie theatre, an idea that can also be extended to cover asset tracking, as described elsewhere herein. At 1700, a pointer device is pointed in one or more directions to intersect with a movie theatre as a point of interest. At 1710, one or more endpoints are returned within scope based on the pointing that include a movie theatre. At 1720, the user implicitly or explicitly selects the the movie theatre as the point of interest. At 1730, the pointing based service automatically transmits and the device receives up to date show times, trailer information, concession specials, ticket purchase information, sold out information, etc.

### Supplemental Context Re: Pointing Device Scenarios

With respect to a representative set of user settings, a number or maximum number of desired endpoints delivered as results can be configured. How to filter can also be configured, e.g., 5 most likely, 5 closest, 5 closest to 100 feet away, 5 within category or sub-category, alphabetical order, etc. In each case, based on a pointing direction, implicitly a cone or other cross section across physical space is defined as a scope of possible points of interest. In this regard, the width or deepness of this cone or cross section can be configurable by the user to control the accuracy of the pointing, e.g., narrow or wide radius of points and how far out to search.

To support processing of vector information and aggregating POI databases from third parties, a variety of storage techniques, such as relational storage techniques can be used. For instance, Virtual Earth data can be used for mapping and aggregation of POI data can occur from third parties such as Tele Atlas, NavTeq, etc. In this regard, businesses not in the POI database will want to be discovered and thus, the service provides a similar, but far superior from a spatial relevance standpoint, Yellow Pages experiences where businesses will desire to have their additional information, such as menus, price sheets, coupons, pictures, virtual tours, etc. accessible via the system.

In addition, a synchronization platform or framework can keep the roaming caches in sync, thereby capturing what users are looking at and efficiently processing changes. Or, where a user goes offline, local changes can be recorded, and when the user goes back online, such local changes can be synchronized to the network or service store. Also, since the users are in effect pulling information they care about in the here and in the now through the act of pointing with the device, the system generates high cost per thousand impression (CPM) rates as compared to other forms of demographic targeting. Moreover, the system drives impulse buys, since the user may not be physically present in a store, but the user may be near the object, and by being nearby and pointing at the store, information about a sale concerning the object can be sent to the user.

As mentioned, different location subsystems, such as tower triangulation, GPS, A-GPS, E-GPS, etc. have different tolerances. For instance, with GPS, tolerances can be achieved to about 10 meters. With A-GPS, tolerances can be tightened to about 12 feet. In turn, with E-GPS, tolerance may be a different error margin still. Compensating for the different tolerances is part of the interpretation engine for determining intersection of a pointing vector and a set of points of interest. In addition, a distance to project out the pointing vector can be explicit, configurable, contextual, etc.

In this regard, the various embodiments described herein can employ any algorithm for distinguishing among boundaries of the endpoints, such as boundary boxes, or rectangles, triangles, circles, etc. As a default radius, e.g., 150 feet could be selected, and such value can be configured or be context sensitive to the service provided. On-line real estate sites can be leveraged for existing POI information. Since different POI databases may track different information at different granularities, a way of normalizing the POI data according to one convention or standard can also be implemented so that the residential real estate location data of Zillow can be integrated with GPS information from Starbucks of all the Starbucks by country.

In addition, similar techniques can be implemented in a moving vehicle client that includes GPS, compass, accelerometer, etc. By filtering based on scenarios (e.g., I need gas), different subsets of points of interest (e.g., gas stations) can be determined for the user based not only on distance, but actual time it may take to get to the point of interest. In this regard, while a gas station may be 100 yards to the right off the highway, the car may have already passed the corresponding exit, and thus more useful information to provide is what gas station will take the least amount of time to drive from a current location based on direction/location so as to provide predictive points of interest that are up ahead on the road, and not already aged points of interest that would require turning around from one's destination in order to get to them.

For existing motor vehicle navigation devices, or other conventional portable GPS navigation devices, where a device does not natively include directional means such as a compass, the device can have an extension slot that accommodates direction information from an external directional device, such as a compass. Similarly, for laptops or other portable electronic devices, such devices can be outfitted with a card or board with a slot for a compass. While any of the services described herein can make web service calls as part of the pointing and retrieval of endpoint process, as mentioned, one advantageous feature of a user's locality in real space is that it is inherently more limited than a general Internet search for information. As a result, a limited amount of data can be predictively maintained on a user's device in cache memory and properly aged out as data becomes stale.

Any device can include the embodiments described herein, including MP3 players, such as a Zune device, GPS navigation devices, bike computers, sunglass/visor systems, motor vehicles, mobile phones, laptops, PDA, etc.

One way to obtain the service applications, assuming the underlying measuring instruments to participate in the real-time gathering of directional information, is to message to a service to obtain the application, e.g., by text messaging to service, or getting a client download link. Another vehicle for enabling the service is to provide it natively in the operating system or applications of a mobile devices. Since a hardware abstraction layer accommodates different methods for collecting position, direction, acceleration information, the same platform can be used on any device regardless of the precise underlying hardware.

In another aspect of any of the embodiments described herein, because stateless messaging is employed, if communications drop with one network, the device can begin further communicating via another network. For instance, a device has two channels, and a user gets on a bus, but no longer have GPRS or GPS activity. Nonetheless the user is able to get the information the device needs from some other channel. Just because a tower, or satellites are down, does not mean that the device cannot connect through an alternative channel, e.g., the bus's GPS location information via Bluetooth.

With respect to exemplary mobile client architectures, a representative device can include, as described variously herein, client Side Storage for housing and providing fast access to cached POI data in the current region including associated dynamically updated or static information, such as annotations, coupons from businesses, etc. This includes usage data tracking and storage. In addition, regional data can be a cached subset of the larger service data, always updated based on the region in which the client is roaming. For instance, POI data could include as a non-limiting example, the following information:

| | |
|---|---|
| POI coordinates and data | //{−70.26322, 43.65412, |

“STARBUCK'S”}

| | |
|---|---|
| Localized annotations | //Menu, prices, hours of operation, etc |
| Coupons and ads | //Classes of coupons (new user, |

returning, etc)

Support for different kinds of information (e.g., blob v structured information (blob for storage and media; structured for tags, annotations, etc.)

A device can also include usage data and preferences to hold settings as well as usage data such as coupons “activated,” waypoints, businesses encountered per day, other users encountered, etc. to be analyzed by the cloud services for business intelligence analysis and reporting.

A device can also include a continuous update mechanism, which is a service that maintains the client's cached copy of a current region updated with the latest. Among other ways, this can be achieved with a ping-to-pull model that pre-fetches and swaps out the client's cached region using travel direction and speed to facilitate roaming among different regions. This is effectively a paging mechanism for upcoming POIs. This also includes sending a new or modified POI for the region (with annotations+coupons), sending a new or modified annotation for the POIs (with coupons), or sending a new or modified coupon for the POI.

### Exemplary Portable Pointing Devices

The scenarios for portable pointing devices are predicated on a device that can be pointed at objects by a user. Accordingly, for context for such pointing devices, in various embodiments, a portable electronic device includes a positional component for receiving positional information as a function of a location of the portable electronic device and a directional component that outputs direction information as a function of an orientation of the portable electronic device. A location based engine also processes the positional information and the direction information to determine a subset of points of interest relative to the portable electronic device as a function of at least the positional information and the direction information.

Accordingly, in various non-limiting embodiments, mobile computing devices can include solid state or magnetic compasses, which allow users to point their handsets to a location of interest, instead of engaging in a conventional search, and gain synchronized information about a location from an owner of the endpoint, one or more third parties, or a web service, such as a mapping service.

As described in more detail below, leveraging digital compasses and GPS to provide direction and location information enables a next-generation of location based search services, discoverability services and mobile gaming services, where the digital compass and GPS can be used as a pointing device. Using a digital compass, e.g., solid state, magnetic, sun/moon based, etc. on a mobile endpoint facilitates point and upload scenarios, point and synchronize geographical information to a Web service, cloud services or another endpoint.

The positional component can be a positional GPS component for receiving GPS data as the positional information. The directional component can be a magnetic compass and/or a gyroscopic compass that outputs the direction information. The device can include acceleration component(s), such as accelerometer(s), that outputs acceleration information associated with movement of the portable electronic device. A separate sensor can also be used to further compensate for tilt and altitude adjustment calculations.

In one embodiment, the device includes a cache memory for dynamically storing a subset of endpoints of interest that are relevant to the portable electronic device and at least one interface to a network service for transmitting the positional information and the direction information to the network service. In return, based on real-time changes to the positional information and direction/pointing information, the device dynamically receives in the cache memory an updated subset of endpoints that are potentially relevant to the portable electronic device.

For instance, the subset of endpoints can be updated as a function of endpoints of interest within a pre-defined distance substantially along a vector defined by the orientation of the portable electronic device. Alternatively or in addition, the subset of endpoints can be updated as a function of endpoints of interest relevant to a current context of the portable electronic device. In this regard, the device can include a set of Representational State Transfer (REST)-based application programming interfaces (APIs), or other stateless set of APIs, so that the device can communicate with the service over different networks, e.g., Wi-Fi, a GPRS network, etc. or communicate with other users of the service, e.g., Bluetooth. For the avoidance of doubt, the embodiments are in no way limited to a REST based implementation, but rather any other state or stateful protocol could be used to obtain information from the service to the devices.

The directional component outputs direction information including compass information based on calibrated and compensated heading/directionality information. The directional component can also include direction information indicating upward or downward tilt information associated with a current upward or downward tilt of the portable electronic device, so that the services can detect when a user is pointing upwards or downwards with the device in addition to a certain direction. The height of the device itself can also be taken into account to distinguish between an event of pointing with a device from the top of a building (likely pointing to other buildings, bridges, landmarks, etc.) and the same event from the bottom of the building (likely pointing to a shop at ground level). One can also use a 3-axis magnetic field sensor to implement a compass to obtain tilt readings.

In this respect, a gesturing component can also be included in the device to determine a current gesture of a user of the portable electronic device from a set of pre-defined gestures. For instance, gestures can include zoom in, zoom out, panning to define an arc, all to help filter over potential subsets of points of interest for the user.

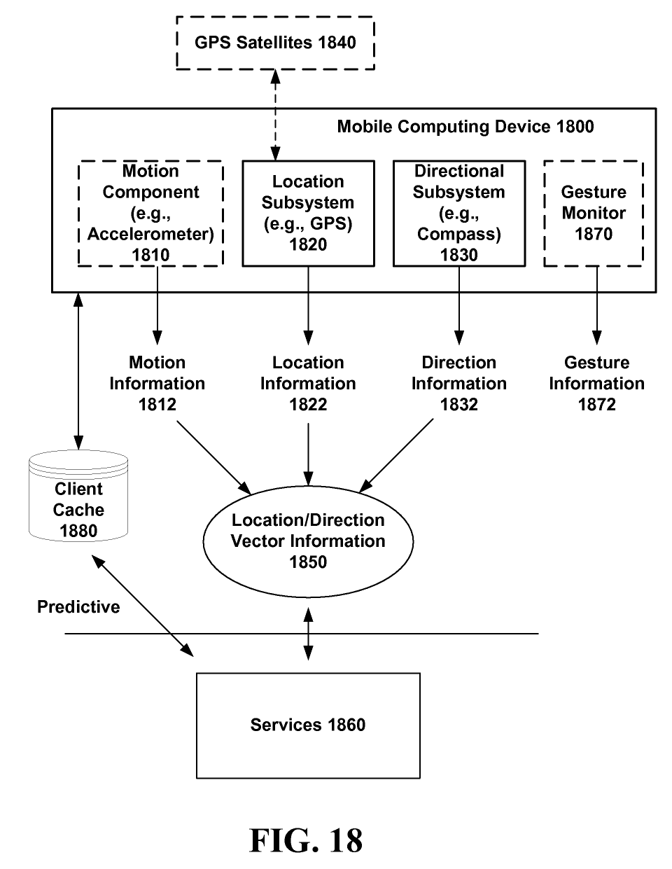

For instance, FIG. 18 illustrates a mobile computing device 1800 according to an embodiment. In this regard, a set of services 1860 can be built based on location information 1822 and direction information 1832 collected by the phone. For instance, location information 1822 can be recorded by a location subsystem 1820 such as a GPS subsystem communicating with GPS satellites 1840. Direction or pointing information 1832 can be collected by a direction subsystem 1830, such as a compass, e.g., gyroscopic, magnetic, digital compass, etc. In addition, optionally, movement information 1812 can be gathered by the device 1800, e.g., via tower triangulation algorithms, and/or acceleration of the device 1800 can be measured as well, e.g., with an accelerometer. The collective information 1850 can be used to gain a sense of not only where the device 1800 is located in relation to other potential points of interest tracked or known by the overall set of services 1860, but also what direction the user is pointing the device 1800, so that the services 1860 can appreciate at whom or what the user is pointing the device 1800.

In addition, a gesture subsystem 1870 can optionally be included, which can be predicated on any one or more of the motion information 1812, location information 1822 or direction information 1832. In this regard, not only can direction information 1832 and location information 1822 be used to define a set of unique gestures, but also motion information 1812 can be used to define an even more complicated set of gestures.

In one embodiment, information is predictively stored/updated in a local cache of the user/device, so that information about endpoints of potential interest to a user's present position and path is already available on the device by the time the information is of interest.

Thus, a device 1800 can include a client side cache 1880 of potentially relevant points of interest, which, based on the user's movement history can be dynamically updated. The context, such as geography, speed, etc. of the user can be factored in when updating. For instance, if a user's velocity is 2 miles an hour, they may be walking and interested in updates at a city block by city block level, or at a lower level granularity if they are walking in the countryside. Similarly, if a user is moving on a highway at 60 miles per hour, the block-by-block updates of information are no longer desirable, but rather a granularity can be provided and predictively cached on the device 1800 that makes sense for the speed of the vehicle.

In various alternative embodiments, gyroscopic or magnetic compasses can provide directional information. A REST based architecture enables data communications to occur over different networks, such as Wi-Fi and GPRS architectures. REST based APIs can be used, though any stateless messaging can be used that does not require a long keep alive for communicated data/messages. This way, since networks can go down with GPRS antennae, seamless switching can occur to Wi-Fi or Bluetooth networks to continue according to the pointing based services enabled by the embodiments described herein. The device includes a file system to interact with a local cache, store updates for synchronization to the service, exchange information by Bluetooth with other users of the service, etc. Accordingly, operating from a local cache, at least the data in the local cache is still relevant at a time of disconnected, the user can still interact with the data, and finally synchronize according to any updates made when re-connected to the network, or to another device that has more up to date GPS data, POI data, etc. In this regard, a switching architecture is adopted for the device to perform a quick transition from connectivity from one networked system (e.g., cell phone towers) to another computer network (e.g., Wi-Fi) to a local network (e.g., mesh network of Bluetooth connected devices).

With respect to user input, a set of soft keys, touch keys, etc. can be provided to facilitate in the directional-based pointing services provided herein. A device can include a windowing stack in order to overlay different windows, or provide different windows of information regarding a point of interest (e.g., hours and phone number window versus interactive customer feedback window). Audio can be rendered or handled as input by the device. For instance, voice input can be handled by the service to explicitly point without the need for a physical movement of the device. For instance, a user could say into a device “what is this building to my right?” and have the device transmit current direction/movement information to a service, which in turn intelligently determines what the building to the right of the user is, and returns a host of relevant information about the building.

In this respect, a device can include a variety of spatial and map components and intelligence to determine intersections for directional arcs. For instance, objects of interest could be represented with exact boundaries, approximated with spheres, subshells (stores in a mall) of a greater shell (mall), hierarchically arranged, etc. Dynamically generated bounding boxes can also be implemented work, i.e., any technique can be used to obtain boundary information for use in an intersection algorithm. Thus, such boundaries can be implicitly or explicitly defined for the POIs. Thus, the device includes an intersection component that interprets pointing information relative to a set of potential points of interest. The engine can perform such intersections knowing what the resolutions of the measuring instruments are on the device, such as the resolution of a GPS system.

Such techniques can include taking into account how far a user is from a potential point of interest, the size of the point of interest and how that is defined, as well as the resolution of location instrumentation, such as the GPS system. The device can also optionally include an altimeter, or any other device that gives altitude information. The altitude information can supplement existing location information for certain specialized services where points of interest vary significantly at different altitudes. It is noted that GPS itself has some information about altitude in its encoding.

### Exemplary Networked and Distributed Environments

One of ordinary skill in the art can appreciate that the various embodiments of methods and devices for pointing based services and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

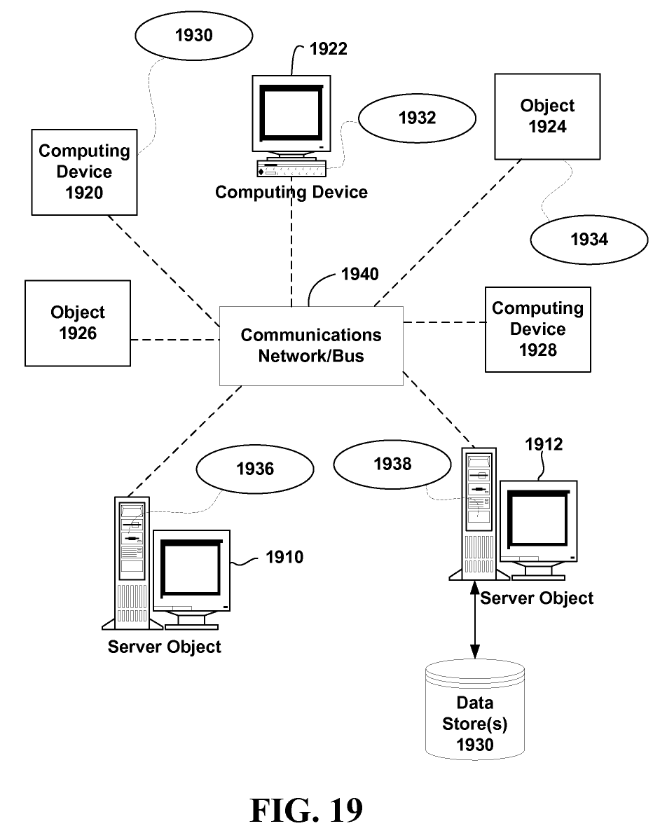

FIG. 19 provides a non-limiting schematic diagram of an exemplary networked or distributed computing environment. The distributed computing environment comprises computing objects 1910, 1912, etc. and computing objects or devices 1920, 1922, 1924, 1926, 1928, etc., which may include programs, methods, data stores, programmable logic, etc., as represented by applications 1930, 1932, 1934, 1936, 1938. It can be appreciated that objects 1910, 1912, etc. and computing objects or devices 1920, 1922, 1924, 1926, 1928, etc. may comprise different devices, such as PDAs, audio/video devices, mobile phones, MP3 players, laptops, etc.

Each object 1910, 1912, etc. and computing objects or devices 1920, 1922, 1924, 1926, 1928, etc. can communicate with one or more other objects 1910, 1912, etc. and computing objects or devices 1920, 1922, 1924, 1926, 1928, etc. by way of the communications network 1940, either directly or indirectly. Even though illustrated as a single element in FIG. 19, network 1940 may comprise other computing objects and computing devices that provide services to the system of FIG. 19, and/or may represent multiple interconnected networks, which are not shown. Each object 1910, 1912, etc. or 1920, 1922, 1924, 1926, 1928, etc. can also contain an application, such as applications 1930, 1932, 1934, 1936, 1938, that might make use of an API, or other object, software, firmware and/or hardware, suitable for communication with or implementation of the user profiling in a transaction and advertising platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 19, as a non-limiting example, computers 1920, 1922, 1924, 1926, 1928, etc. can be thought of as clients and computers 1910, 1912, etc. can be thought of as servers where servers 1910, 1912, etc. provide data services, such as receiving data from client computers 1920, 1922, 1924, 1926, 1928, etc., storing of data, processing of data, transmitting data to client computers 1920, 1922, 1924, 1926, 1928, etc., although any computer can be considered a client, a server, or both, depending on the circumstances. Any of these computing devices may be processing data, or requesting services or tasks that may implicate the improved user profiling and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1940 is the Internet, for example, the servers 1910, 1912, etc. can be Web servers with which the clients 1920, 1922, 1924, 1926, 1928, etc. communicate via any of a number of known protocols, such as the hypertext transfer protocol (HTTP). Servers 1910, 1912, etc. may also serve as clients 1920, 1922, 1924, 1926, 1928, etc., as may be characteristic of a distributed computing environment.

### Exemplary Computing Device

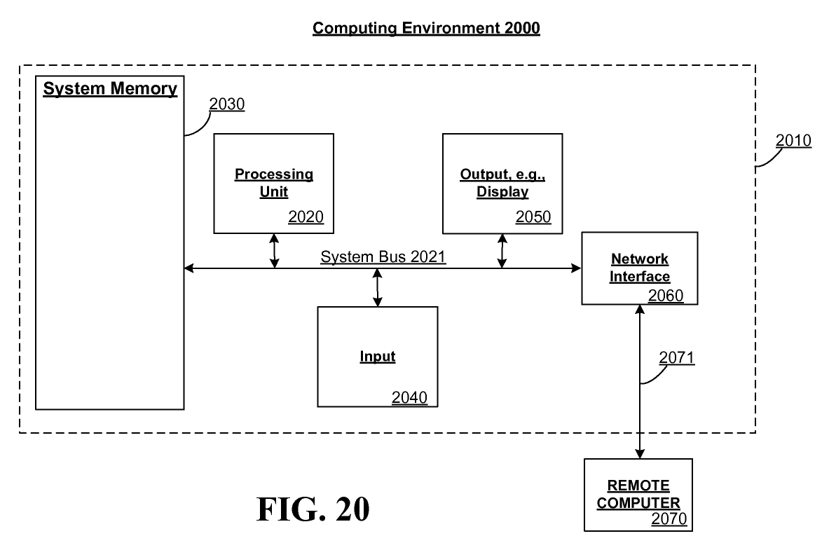

As mentioned, various embodiments described herein apply to any device wherein it may be desirable to perform pointing based services. It should be understood, therefore, that handheld, portable and other computing devices and computing objects of all kinds are contemplated for use in connection with the various embodiments described herein, i.e., anywhere that a device may request pointing based services. Accordingly, the below general purpose remote computer described below in FIG. 20 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 20 thus illustrates an example of a suitable computing system environment 2000 in which one or more of the embodiments may be implemented, although as made clear above, the computing system environment 2000 is only one example of a suitable computing environment and is not intended to suggest any limitation as to the scope of use or functionality of any of the embodiments. Neither should the computing environment 2000 be interpreted as having any dependency or requirement relating to any one or combination of components illustrated in the exemplary operating environment 2000.

With reference to FIG. 20, an exemplary remote device for implementing one or more embodiments herein can include a general purpose computing device in the form of a handheld computer 2010. Components of handheld computer 2010 may include, but are not limited to, a processing unit 2020, a system memory 2030, and a system bus 2021 that couples various system components including the system memory to the processing unit 2020.

Computer 2010 typically includes a variety of computer readable media and can be any available media that can be accessed by computer 2010. The system memory 2030 may include computer storage media in the form of volatile and/or nonvolatile memory such as read only memory (ROM) and/or random access memory (RAM). By way of example, and not limitation, memory 2030 may also include an operating system, application programs, other program modules, and program data.

A user may enter commands and information into the computer 2010 through input devices 2040 A monitor or other type of display device is also connected to the system bus 2021 via an interface, such as output interface 2050. In addition to a monitor, computers may also include other peripheral output devices such as speakers and a printer, which may be connected through output interface 2050.

The computer 2010 may operate in a networked or distributed environment using logical connections to one or more other remote computers, such as remote computer 2070. The remote computer 2070 may be a personal computer, a server, a router, a network PC, a peer device or other common network node, or any other remote media consumption or transmission device, and may include any or all of the elements described above relative to the computer 2010. The logical connections depicted in FIG. 20 include a network 2071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to derive information about surrounding points of interest.

There are multiple ways of implementing one or more of the embodiments described herein, e.g., an appropriate API, tool kit, driver code, operating system, control, standalone or downloadable software object, etc. which enables applications and services to use the pointing based services. Embodiments may be contemplated from the standpoint of an API (or other software object), as well as from a software or hardware object that provides pointing platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists. Similarly, where a method is practiced, a corresponding device can be provided that practices that method via one or more components.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for a device provisioned for pointing based services, comprising:
receiving direction information associated with at least one direction of the device;
dynamically defining an area of intersection within scope for the at least one direction including defining the area of intersection as a function of a current state or parameter of the service or the device; and
identifying at least one person of interest that substantially intersects or lies within the at least one area of intersection.

2. The method of claim 1, wherein the receiving direction information includes receiving at least one filter criteria for filtering the at least one person of interest.

3. The method of claim 1, wherein the identifying includes identifying at least one person of interest that substantially intersect with the at least one direction according to an intersection determination;
displaying static and dynamic information associated with the at least one person of interest; and
receiving input relating to the dynamic information including receiving input relating to sending a message to the at least one person of interest.

4. The method of claim 2, further comprising synchronizing the message to a network service in response to the receiving input.

5. The method of claim 2, wherein the receiving input includes receiving changes to the dynamic information.

6. The method of claim 2, further comprising:
interacting with the dynamic information including making changes to the dynamic information.

7. The method of claim 6, wherein the interacting includes interacting with a social networking application profile of the at least one person of interest.

8. A method for a device provisioned for pointing based services, comprising:
receiving direction information associated with at least one direction of the device;
determining at least one place associated with the at least one direction of the device that substantially intersect with the at least one direction according to an intersection determination; and
identifying at least one person of interest in the at least one place based on information from a network service.

9. The method of claim 8, further comprising:
displaying static and dynamic information associated with at least one person of interest.

10. The method of claim 9, further comprising:
interacting with the dynamic information including making changes to the dynamic information; and
synchronizing the changes to the network service.

11. The method of claim 8, further comprising:
receiving dynamically targeted content from the at least one person of interest.

12. The method of claim 11, further comprising:
receiving input from an interaction with the dynamically targeted content.

13. The method of claim 11, further comprising:
anonymizing and uploading interaction history between the device and dynamically targeted content of the at least one person of interest.

14. A device provisioned for pointing based services, comprising:
a person selection component for identifying at least one person of interest;
a map component for retrieving map-based information from a pointing based service, the map-based information including location, direction and movement information for the at least one person of interest; and
a rendering component that renders the at least one person of interest in relation to the device on a map on display on the device.

15. The device of claim 14, wherein the rendering component renders the at least one person of interest and simulates the motion of the at least one person of interest and device based on the location, direction and movement information of the at least one person of interest and device.

16. The device of claim 14, wherein the rendering component renders directional information for the at least one person of interest including a representation of at least one motion vector to show direction, speed and location of the at least one person of interest based on the location, direction and movement information.

17. The device of claim 14, wherein the map component loses connectivity to a first network with location information that communicatively couples the device to the pointing based service, identifies at least one other source of location information to which the device connects on a second network; and automatically connects to the second network to receive the location information from the at least one other source.

18. The device of claim 14, wherein the location information is global positioning satellite (GPS) information.

19. The device of claim 17, wherein the at least one other source is a different pointing based services enabled device and the second network is Bluetooth.

20. The device of claim 14, further comprising:
an airplane identification component that identifies an airplane and receives direction information, motion information and location information associated with at least one direction of the airplane,
wherein the rendering component identifies one or more points of interest that substantially intersect in at least one region below the airplane according to the direction information, motion information and location information, and
wherein the rendering component further displays static or dynamic information associated with the one or more points of interest retrieved from a pointer based service.

21. The device of claim 14, further comprising:
a mesh network component that offers opt in to a mesh network of at least one pointing based service that tracks at least one point of interest based on pointing of associated pointing devices, receives input according to the at least one pointing based service and records the path history of the device corresponding to historical location and direction information of the device; and
an interface for uploading the path history of the device to benefit all devices that have opted into the mesh network.
